(19) United States
(12) Patent Application Publication
(10) Pub. No.: US 2018/0357545 A1
(43) Pub. Date: Dec. 13, 2018

(54) ARTIFICIAL CONNECTOMES

(71) Applicant: PROME, Inc., New York, NY (US)

(72) Inventors: Timothy Busbice, Westlake Village, CA (US); Sean Everett, New York, NY (US)

(21) Appl. No.: 15/658,382

(22) Filed: Jul. 24, 2017

Related U.S. Application Data
(60) Provisional application No. 62/516,920, filed on Jun. 8, 2017.

(51) Int. Cl. G06N 3/08; G06N 3/04

(52) U.S. Cl. CPC G06N 3/082; G06N 3/0472; G06N 3/049; G06N 3/0445

(57) ABSTRACT

A method and system are provided for the creation and use of artificial connectomes for the purpose of invoking the sensing of various inputs, processing the input paradigms and causing motor output that can be used to develop contextual evidence of the paradigm being sensed. Encoded sensory data is passed to an artificial connectome, where such connectome is based on the guiding principles of how animal nervous systems are wired and modulated, with the resulting processed data terminating in physical movement or virtual motor output that can be expressed as output and/or provide feedback input into the sensory input data feed. The entire system comprises an emulation of animal nervous systems from sensory input to motor output that can be used for various general intelligence purposes.

### RELATED APPLICATION DATA

The present application is related to, and claims the benefit of, commonly-owned co-pending U.S. Application Ser. No. 62/516,920 entitled BUILDING ARTIFICIAL CONNECTOMES, filed on Jun. 8, 2017, which application is incorporated herein by reference in its entirety.

### TECHNICAL FIELD

The present invention relates generally to artificial intelligence and, in particular, to creating and using artificial connectomes.

### BACKGROUND ART

Biologic Intelligence is classified as artificial general intelligence because it can generalize the environment in that it can digest a few environmental factors and from the connectomic nature, further understand like instances. Biologic Intelligence does not requires huge training sets. Like an animal, once a Biologic Intelligence system encounters like items and instances, it will react very similar if faced with a similar but unfamiliar situation in its future. For example, a 2-3 year old child can understand what a chair is by observing a chair in a living and/or dining room. If the same child is taken into an office space, the child will understand what an office chair is without prior knowledge. On the other hand, a Deep Learning system would most likely have to be shown many examples of office chairs before it could identify an office chair.

### SUMMARY OF THE INVENTION

A method and system are provided for the creation and use of artificial connectomes for the purpose of invoking the sensing of various inputs, processing the input paradigms and causing motor output that can be used to develop contextual evidence of the paradigm being sensed. Encoded sensory data is passed to an artificial connectome, where such connectome is based on the guiding principles of how animal nervous systems are wired and modulated, with the resulting processed data terminating in physical movement or virtual motor output that can be expressed as output and/or provide feedback input into the sensory input data feed. The entire system comprises an emulation of animal nervous systems from sensory input to motor output that can be used for various general intelligence purposes.

### BRIEF DESCRIPTION OF THE DRAWINGS

FIG. 1 illustrates a neuron and an example of the electrical activity resulting from the stimulation of the neuron;

FIG. 2 is a flowchart of an embodiment of a method of the present invention;

FIG. 3 illustrates a simple artificial connectome of the according to embodiments of the present invention compared with a C. elegans connectome;

FIG. 4 illustrates a schematic model of an artificial brain based on artificial connectomes of FIG. 3;

FIG. 5 illustrates an example of three cortical regions of a brain and the connections of neurons within and between the regions;

FIG. 6 represents a simple two-neuron connectome having a single edge with recurrence;

FIG. 7 represents a simple two-neuron connectome in an inhibitory network;

FIG. 8 is a further example of a two-neuron inhibitory network;

FIG. 9 is a further example of a two-neuron inhibitory network with a delay;

FIG. 10 is a schematic example of a higher level connectome model according to embodiments of the present invention;

FIG. 11 is a schematic representation of a robot system incorporating the connectome model according to embodiments of the present invention; and

FIG. 12 is a graph representing sensor data processed through the connectome model according to embodiments of the present invention.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

### INTRODUCTION

Embodiments of the present invention relate to the field of Biologic Intelligence and provide models and methods for creating and using artificial connectomes. We realized early on that although we have the means to emulate any animal nervous system, we find that there are numerous innate behaviors programmed into an animal's connectome that at least at this time, impossible to remove without causing issues with other desired behaviors. Removing even a single neuron can cause a lot or unforeseen problems and undesirable behaviors. Thus we have cataloged certain connectomic rules that give us the ability to create a connectome and then use that connectome for whatever purpose it is needed.

Biologic Intelligence differs from other artificial intelligence (AI) paradigms (Deep Learning, Convolutional neural networks) because Biologic Intelligence learns and adjusts to the environment as it develops an understanding of its environment (i.e. plasticity). Other AI paradigms must be trained and usually with enormous data sets (millions of items) and the output created by the input of these sets, must be classified and delineated. Likewise, Biologic Intelligence can be trained in the same manner as other AI paradigms but has two factors that allow it to operate unsupervised: 1) the connectomic nature has built in control features that can override and operate in unfamiliar environments, and without prior knowledge of that environment; and 2) Biologic Intelligence can develop new understanding through plasticity, much like animal nervous systems, where the Biologic Intelligence system can learn new behaviors based on new input from its environment and feedback input based on its own motor activity. Biologic Intelligence can create a system that is self-aware, albeit at a low level.

Furthermore, from our current research, we have shown that modeling animal nervous systems or creating artificial connectomes does not require the computing resources that other popular AI paradigms require. Being able to create intelligent systems that can be executed on ordinary computing resources gives great advantage by allowing small, self-contained intelligence systems, independent of external computing resources but deliver tremendous value.

### I. Neurons

Emulation of a neuron is the basic building block of Biologic Intelligence. We have taken a very simple view of a neuron with the basic concept, like animal neurons, with the all or none response. The all or none response is based on the accumulation of values (weights) and once that accumulation exceeds a certain threshold, the neuron fires or sends weighted values to the neurons it is networked too.

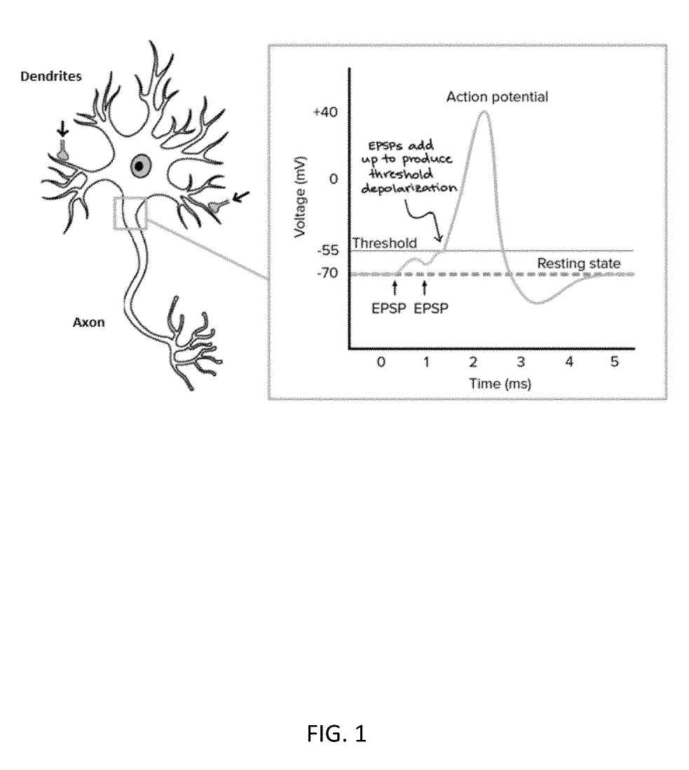

In a biological neuron, synapses from a presynaptic neuron terminate on the dendrites of a postsynaptic neuron and as those synapsis are activated and reach a certain threshold, the neuron will send a electrochemical pulse down its axon which activates synapses that connect the neuron to other neurons. An example is illustrated in FIG. 1.

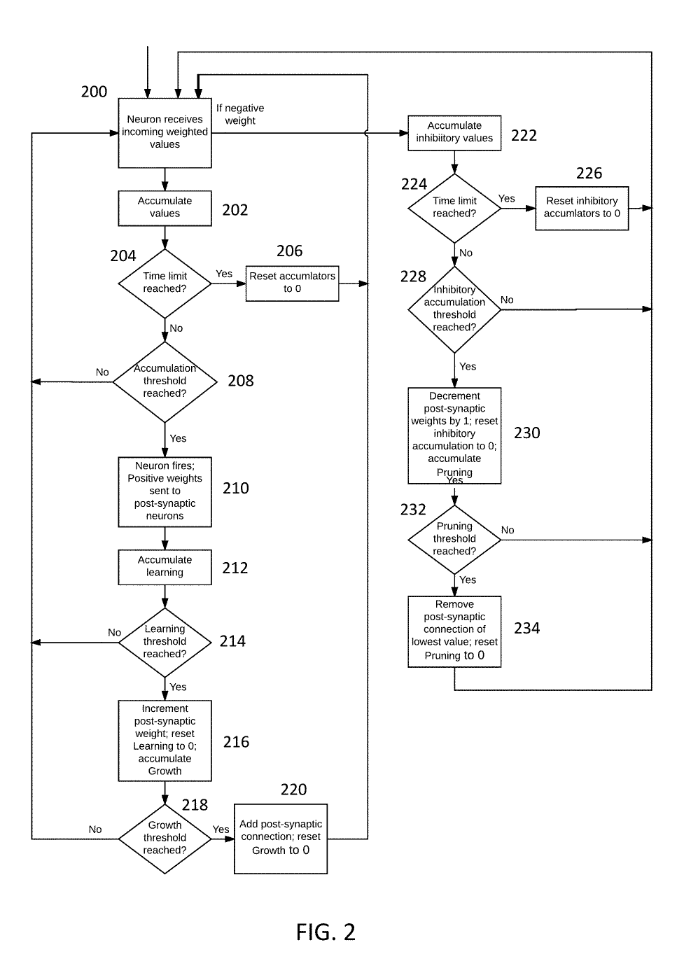

PROME, the project that is the basis for the present invention, emulates this basic concept programmatically. The basic principles of a single PROME neuron are as follows and as illustrated in the chart of FIG. 2. It will be appreciated that not all of the steps need to occur in the order indicated in the flowchart or in the following description. Further, some steps may be omitted or other steps added in some embodiments.

A) A neuron only connects to other neurons in a feed forward fashion; i.e. a neuron cannot connect to itself. However a neuron can connect back to any neuron that connects to it.

B) A neuron receives weighted values from other neurons (step 200) and the weights accumulate (step 202). Weighted values can be positive (excitatory) or negative (inhibitory) values but never zero. Values start off usually between −3 to +4. It has been noted that the distribution of weighted values, the value sent between neuronal connections, can be set randomly. The weighted values differ to some small amount. In the original experiments, the weights were determined by the number of connections between neurons. For instance the C elegans neuron ADAL has four synaptic connections to neuron AVBL. We deduce that when ADAL fires, all four synapses to AVBL will activate thus we capsulize this into a weighted value of 4 between ADAL to AVBL.

C) If the neuron is inactive for a predetermined time (that is, the neuron hasn't fired for a period of time) (step 204), the accumulators (see the following steps) are reset to zero and the threshold value is set to its initial value (step 206). The neuron then returns to its initial state to receive weighted values from other neurons (step 200). The time limit may be approximately 500 ms+/−200 ms.

D) A threshold value is set that is used to determine when an emulated neuron will fire. This value can vary depending on the speed on the computer in general. This value has been set between 7 and 30. The value can be set as part of a tuning process, such as beginning with a value of 15.

E) Once the accumulated incoming weighted values is greater than the threshold (step 208), the emulated neuron will fire and send its stored weighted values to the neurons to which it is connected (step 210).

F) To emulate synaptic fatigue, a small value is incremented to the threshold when the neuron fires (step 210). Synaptic fatigue in biology is when a neuron repeatedly fires, it starts to lose its stored neurotransmitter and eventually will slow down its ability to fire. If a neuron repeatedly fires it will accumulate a “Learning” value (step 212). If the accumulated Learning value exceeds a learning threshold (step 214), synaptic growth is simulated, adding a synapse to an already existing neuron to neuron connection, by increasing the value of the weights. In addition, the accumulated learning value is reset to zero and a Growth value accumulates (step 216).

G) If the Growth value exceeds a growth threshold (step 218), the neuron will create a connection to a neuron that it had not previously connected to (step 220) and the neuron returns to its initial state to receive weighted values from other neurons (step 200).

H) If the various thresholds are not exceeded (steps 208, 214, 218), the neuron returns to its initial state to receive weighted values from other neurons (step 200).

I) In both Learning and Growth, there are weighted value caps applied to the number of synapse that can be grown. This is to temper the potential for a single neuron being connected to every neuron with huge weighted values.

J) Counter to overall accumulation and growth is the capture of inhibitory weighted values (step 222) and just the same as Learning and Growth, if the inhibitory neurons accumulate repeatedly, the emulated neuron will remove connections and decrease weight values to other the neurons it is connected to (steps 224-234).

### II. Creating a Connectome

The real value and difference between PROME and all other AI paradigms is the connectomic network features. The network dynamics created by the connectome is what gives animals the means to generalize and learn their environments. PROME uses rules and principles to develop artificial connectomes. These connectomes are stored simply as Presynaptic Neuron (Source Node), Postsynaptic Neuron (Target Node) and the weighted value between the two. In total, using classic AI terminology, this defines the Edge.

To see a subset of the C elegans connectome, it looks like:

| Presyn | Postsyn | Weight |
|---|---|---|
| ADAL | ADAR | 1 |
| ADAL | ADFL | 1 |
| ADAL | AIBL | 1 |
| ADAL | AIBR | 2 |
| ADAL | ASHL | 1 |
| ADAL | AVAR | 2 |
| ADAL | AVBL | 4 |
| ADAL | AVBR | 7 |
| ADAL | AVDL | 1 |
| ADAL | AVDR | 2 |
| ADAL | AVEL | 1 |
| ADAL | AVJR | 5 |
| ADAL | FLPR | 1 |
| ADAL | PVQL | 1 |
| ADAL | RICL | 1 |
| ADAL | RICR | 1 |
| ADAL | RIML | 3 |
| ADAL | RIPL | 1 |
| ADAL | SMDVR | 2 |
| ADAR | ADAL | 1 |
| ADAR | ADFR | 1 |
| ADAR | AIBL | 1 |
| ADAR | AIBR | 1 |
| ADAR | ASHR | 1 |

Likewise, an artificial connectome may look like:

| Source | Target | Weight |
|---|---|---|
| CD300000799 | CE300000798 | −1 |
| CD300000799 | CE300000800 | −1 |
| CD300000799 | CE300000801 | −1 |
| CE300000800 | CI300000800 | 1 |
| CE300000800 | CE100000800 | 3 |
| CI300000800 | CE300000800 | −4 |
| CE300000800 | CE500000800 | 1 |
| CE300000800 | CE600000800 | 2 |
| CE300000800 | CD300000800 | 1 |
| CD300000800 | CE300000798 | −1 |
| CD300000800 | CE300000799 | −1 |
| CD300000800 | CE300000801 | −1 |
| CD300000800 | CE300000802 | −1 |
| CE300000801 | CI300000801 | 2 |
| CE300000801 | CE100000801 | 3 |
| CI300000801 | CE300000801 | −4 |
| CE300000801 | CE500000801 | 3 |
| CE300000801 | CE600000801 | 3 |
| CE300000801 | CD300000801 | 1 |
| CD300000801 | CE300000799 | −1 |
| CD300000801 | CE300000800 | −1 |
| CD300000801 | CE300000802 | −1 |
| CD300000801 | CE300000803 | −1 |

The following are connectomic observations/rules in no particular order. Note that these are purely connectomic properties and do not place emphasis on the intracellular activity of individual neurons.
A) The connectome is always on. Our nervous systems never shut down, they are always active. Having emulated animal connectomes, we once ran a test of an emulated connectome with some initial sensory input that started the cortical processing and after 24 hours, we turned it off since it was obvious that the neuron to neuron activity would never end. This creates computing issues as well as network issues.
B) The connectome is highly recursive and in many cases, it is exponentially recursive. If we start with a cortical neuron and map out the connections to other neurons, we see that there are a few of those postsynaptic neurons that connect back to the originating neuron. This set of neurons connects to another set of neurons, and from that next set, many connect back to the originating neuron. This goes out to more layers and sets and at each level, there are a number of connections back to the originating neuron. From data analysis, in many cases, we see that this recursive connectivity grows exponentially back to the originating neuron. We believe this is why the connectome is always on as stated in A) above. Further work with high level organisms have shown that the recursive nature of the connectome is more so in local regions of nervous systems and present, but not as connected, between regions of cortex.
C) There are two basic temporal aspects in any nervous system:
   i) As noted in section A), the polarization timing where if a neuron, real or simulated, is left alone or not stimulated over a certain timespan, it polarizes or goes to a negative (or zero) value=internal function of time; i.e. the all or none response.
   ii) The network topology of the connectome is a function of time as well whereas if certain neurons fire before others, a set of behaviors will occur but if a set of those same neurons fire in a different sequence, we often see other behaviors=an external, network timing.
D) There is a dampening effect displayed on muscle output. When we apply connectomes, animal or artificial, to robotics, we observe a lot of neural muscular activity where values are being sent to the motors (muscles) continuously and rapidly but we do not see motors react in a jerky or erratic manner. We observe the motor activity as smooth and continuous. We conject that our cerebellum plays a role in this smoothing of motor output along with the coordination of cortex to motor response.
E) There is a Left-Right component to all (most?) nervous systems. This is obvious but rarely employed, if ever, when creating artificial intelligence and there is an impact on how these Left-Right edges are configured. From data analysis and further emulation of artificial connectomes, we find that connectivity between Right-Right or Left-Left neurons is about two-thirds more than Left-Right or Right-Left connectivity. These hemispheric connections are very important in perceptual direction as well as in sequencing motor output.

Building Artificial Connectomes

Using these observations, we wanted to develop a connectome from scratch that could learn and adapt to whatever sensory input we wanted it to consume. We did some backward data analysis on motor neuron to sensory neuron pathways using animal connectomes and realized some patterns emerging. We could see the way in which neurons were connected was much like the concept purported by the Watts-Strogatz small world algorithm. We created a program that allowed us to construct a connectome using different parameters in the Watts-Strogatz algorithm and ran a simple classification test with each model created.

Given the desired number of nodes N, the mean degree K (assumed to be an even integer), and a special parameter β, satisfying 0≤β≤1 and N>>K>>ln(N)>>1, the model constructs an undirected graph with N nodes and

$$\frac{NK}{2}$$

edges in the following way:
1. Construct a regular ring lattice, a graph with N nodes each connected to K neighbors, K/2 on each side. That is, if the nodes are labeled n₀ . . . n_{N-1}, there is an edge (nᵢ, nⱼ) if and only if

$$0 < \vert i - j \vert mod ( N - 1 - \frac{K}{2} ) \leq \frac{K}{2} .$$

2. For every node nᵢ=n₀, . . . , n_{N-1} take every edge (nᵢ, nⱼ) with j<j, and rewire it with probability β. Rewiring is done by replacing (nᵢ, nⱼ) with (nᵢ, nₖ) where k is chosen with uniform probability from all possible values that avoid self-loops (k≠i) and link duplication (there is no edge (nᵢ, n_{k′}) with k′=k at this point in the algorithm).

Running approximately 100 trials using different configurations, we found that there is a fine line between too much connectivity and too little connectivity. Too much would result in a model that would run continuously once stimulated but would output to all motor neurons/muscles simultaneously and constantly without any discrimination; e.g. all muscles were active all the time. Too little connectivity would result in the connectome taking a very long time to activate any muscle activity, if any in some cases, and the system would cease to self-stimulate once any sensory stimulation was stopped. The mean degree matched against the rewiring probability was very narrow in nature with a resulting connectome that would self-simulate once it had a short amount of sensory input and the motor neuron/muscle output was discriminatory determined by the sensory input.

Theoretical Artificial Nervous Systems

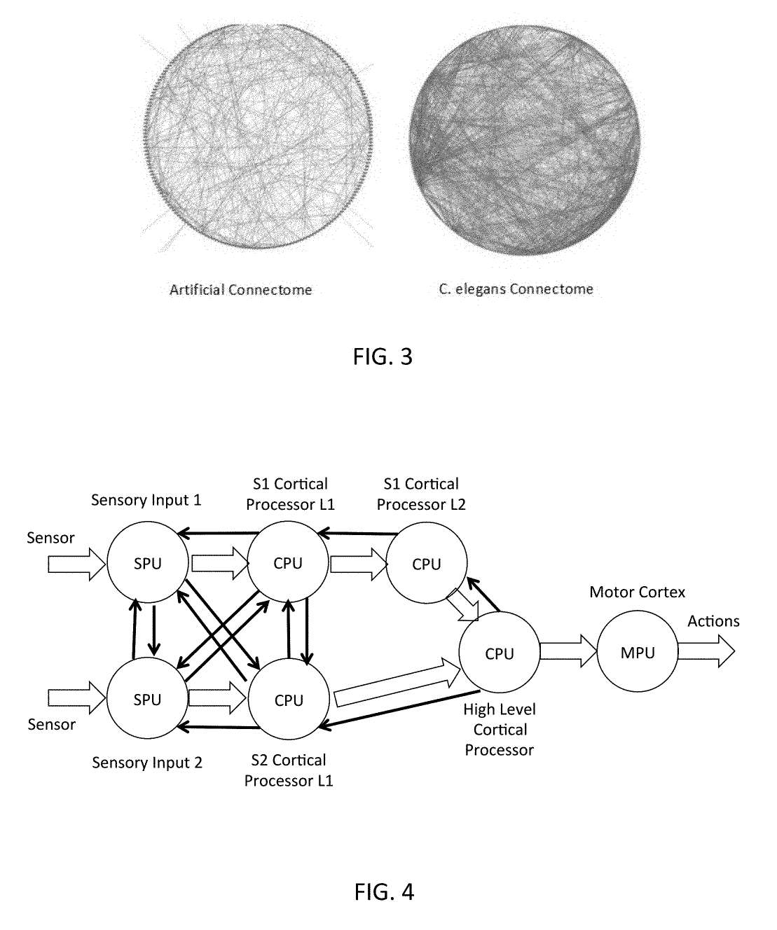

FIG. 3 illustrates a simple artificial connectome compared with the C. elegans connectome. Squares around the circumference are nodes and lines between are edges that connect the nodes.

Each artificial connectome shown in FIG. 3 can be connected to other connectomes and we can create multiple regions, each called a clique, each highly recurrent, with a large degree of interconnectivity between the regions or cliques making recurrent interconnections. Therefore, in theory, we can expand our model of a simple artificial connectome to create an artificial brain as shown in FIG. 4.

Recent studies (Xie K, Fox G E, Liu J, Lyu C, Lee J C, Kuang H, Jacobs S, Li M, Liu T, Song S and Tsien J Z (2016) Brain Computation Is Organized via Power-of-Two-Based Permutation Logic. Front. Syst. Neurosci. 10:95. doi: 10.3389/fnsys.2016.00095) have shown that the number of regions or cliques required are directly correlated to the number of types of information we want to perceive. The formula is N (number of cliques)=2i−1 where i is the number of different types of information. As an example, if we wanted a robot to sense temperature, sonar and camera face recognition, we would need 23−1 or 7 neural cliques or regions.

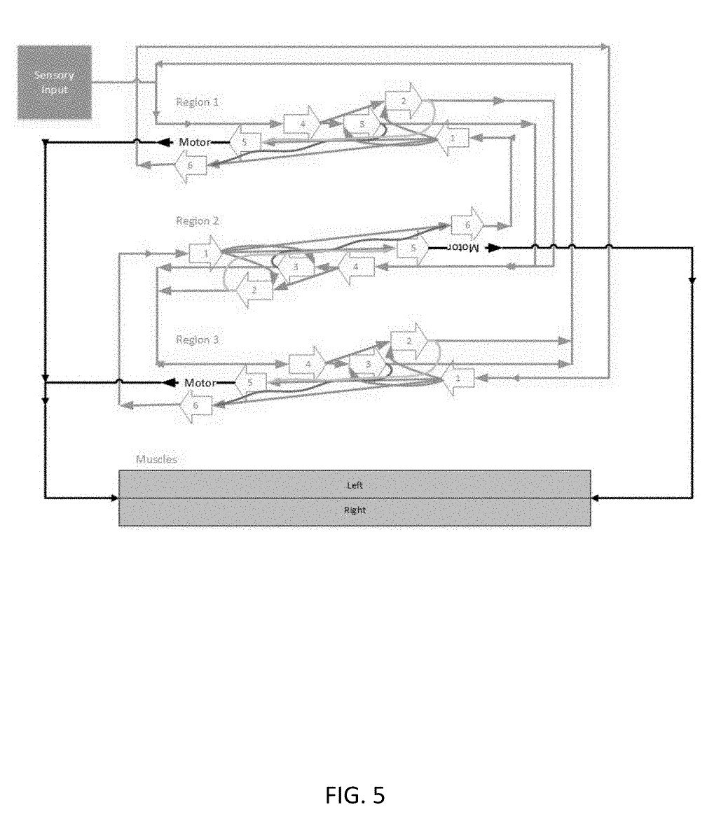

Looking from a different view, after experimenting with an artificial brain concept, we were reminded of efforts we developed about 10 years ago utilizing the six layer concept of a cortical column of the human cortex. Using the concept of the interconnectivity of these cortical columns, we created three cortical regions, each containing several hundred cortical columns and interconnected between the layers in a rudimentary fashion as defined by the functions of each layer. We then added sensory neurons that connected directly to the first region of cortical columns and Left/Right motor neurons that connected to sets of Left/Right muscles, as shown in FIG. 5. The six layer approach worked very well with simple classification tests using a 10×10 grid of pixels representing numeric values.

Higher level animal brains are comprised of Neurons which make up cortical columns which cohere into brain regions or cliques, and regions interconnect to form a whole brain. On either side of a brain is sensory input from sensory organs (e.g. vision, hearing, touch) and motor output to muscles. Everything we do requires motion to stimulate input (real or virtual) and every input to cortical processing results into some motor output (real or virtual). Using Biologic Intelligence, we achieve this same topology and create an entire end-to-end system.

### III. Application of Connectomes

There are two basic ways in which to apply connectomes where each neuron is a standalone program connected through some messaging protocol like UDP or we use Adjacency Matrices where each row represents a connectivity (edge) vector that can be used to increase weighted values as individual neurons are fired. In addition to an adjacency matrix to contain the connections and weights between those connections, in this linear algebraic model there are five other arrays where each cell of the array represents a specific neuron. Those five arrays are:
1) an array to contain the accumulation of weights;
2) an array to contain a timestamp of the last time a neuron was stimulated;
3) an array containing the threshold of a particular neuron;
4) an array containing a “learning” accumulator; and
5) an array containing a “growth” accumulator. Note that the learning and growth accumulators trigger plasticity in the system.

As has been noted already, in emulating animal connectomes, we use an internal temporal aspect of each neuron so that if a neuron has not been stimulated in a few microseconds, all accumulators (i.e. weight, learning and growth) are set to zero and the threshold is set to a default value. For a neuron to fire (to reach its action potential), the weight accumulation must exceed the threshold. Any time a neuron fires, its weight accumulation is set to zero (we have also experimented with negative numbers but the outcome is substantially similar). The weight vector of the adjacency matrix is added to the accumulation array each time a neuron fires and the weights are accumulated. A timer function constantly runs to check when accumulation is greater than the threshold and fires each of the neurons that meets this criteria.

To simulate synaptic fatigue, each time a neuron fires, the threshold for that neuron is incremented by a small amount so that a constant activation of a neuron gets a little harder to exceed the threshold. As mentioned above, the threshold is reset to a default value if a neuron does not fire within a set time frame.

Plasticity is formed in two ways: learning and growth. A “learning” array is incremented when a neuron fires and if that learning accumulation exceeds a learning threshold, weight is increased on the adjacency matrix so where a connection between neuron A to B may have a weight of one, it could be increased by one so now it would be two. This simulates connectivity strength. A “growth” array is incremented when the learning accumulation exceeds the learning threshold. When the growth accumulation exceeds a growth threshold, we add a synaptic connection to a nearby neuron which simulates synaptic growth. As mentioned above, if a specified time has passed since a neuron was stimulated, both the learning and growth accumulators are set to zero; i.e. all accumulation is a function of time.

The strengthening and weakening of the pathways is the crux of Biologic Intelligence for higher level systems that use plasticity for memory. Specific input patterns will create a strengthened pathway that is unique for that input pattern. When that input pattern is sensed again, this pathway is lit up and the motor output is the same. Since the connectome is such a large array and there are so many combinations, Biologic Intelligence can store and process a tremendous amount of data. Considering just eight neurons can produce 8! (factorial) combinations which is equal to 40,320. Add excitatory and inhibitory neurons and multiple layers, one can see very rapidly how a small connectome could learn a tremendous about of information and act on it.

We discovered that the standalone program model for each neuron works best in nervous system emulation; however, there are issues that are difficult to overcome. The main problem is what we call UDP stacking. Messages come in so fast, that the receiving program (Neuron) cannot keep up with the requests over time. After a few minutes, we see erratic behaviors due to the fact that some neurons are still processing messages previous to the current state. This can be solved in various ways by splitting the individual neuronal programs between processors and using fast systems. Ideally the network should be the bottleneck in these instances and not the programs/processors.

Using adjacency matrices and linear algebra allows us to control the timing of the processing so all neurons are equal. Where we run into issues using matrices is also computing power. We have two parameters we can tune to adjust for the multitude of processors we run PROME on: 1) the threshold value, and 2) the function of time to zero. Decreasing the threshold gives slower systems the possibility to react at a slower pace; i.e. the smaller the threshold, the system can react in a faster time frame. Time to zero, likewise, will give the system more time to process before all accumulators are set to zero. We find that we can tweak these values quite quickly to tune for specific machines. We usually always start off with a known connectome and then change depending on how we observe connectomic behavior where that behavior is either little connectomic activity or too much activity.

Simple Connectomes

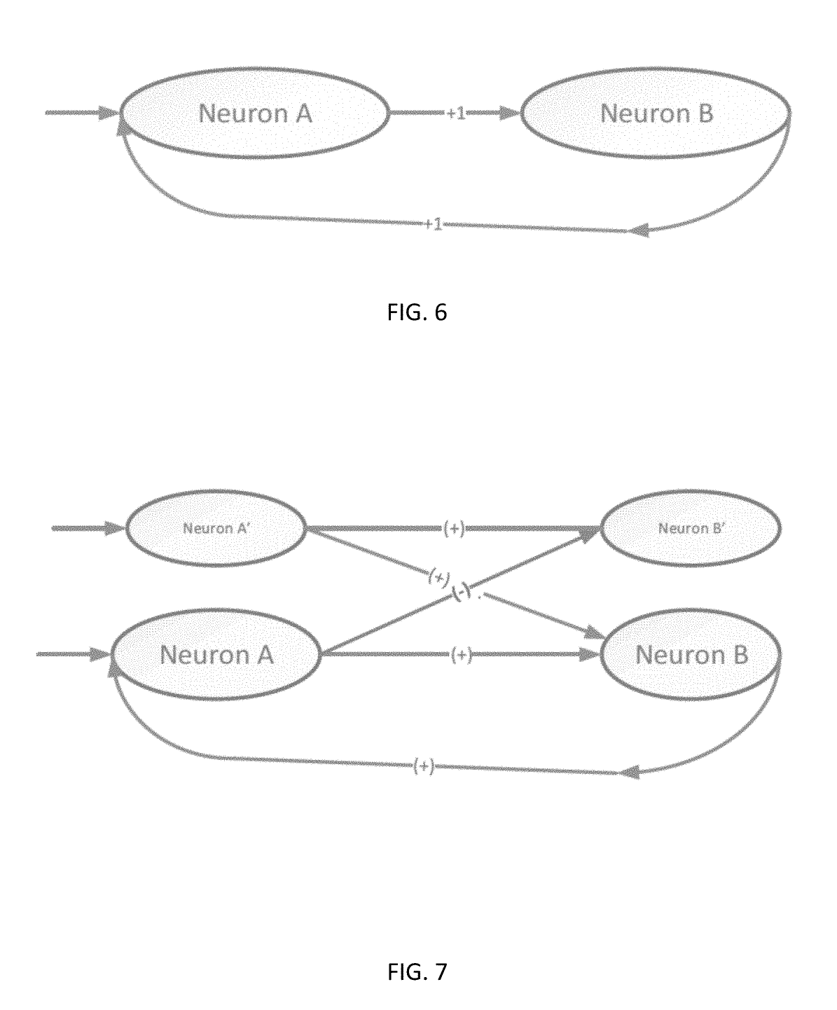

The simplest connectome is a single edge with recurrence, as illustrated in FIG. 6. On the surface, this simple connectome doesn't seem to have any practical value but do not forget about the internal, temporal aspects of a single neuron. Neuron A has to be continuously stimulated in a certain time frame for it to fire. Likewise, Neuron B must also be stimulated by Neuron A with continuous stimulation before it will fire and fire back to Neuron A. This is a simple time switch. However, once stimulation gets the circuit going, we could find that this circuit would run forever. We have observed this phenomena in animal connectomes where two neurons will continuously stimulate one another and although they will stimulate other neurons, the weighted values are not enough to cause the other neurons to fire. This simple motif makes up a lot of what we observe in real animal brains. When just another input source stimulates one or the other neuron, a whole set of neurons become quickly activated.

However, if excitatory pathways were all that existed, we would find very rapidly that our brains would become a very large collection of strong pathways that intertwined and grew and grew until every neuron in the brain would be activated for every sensory input creating a network completely out of control and useless for any type of discrimination. Therefore, we have a mirrored inhibitory network that tunes the excitatory network and will decrease weighted values if stimulated enough over time. This synaptic pruning allows pathways to become more refined and tuned for fine discrimination of sensory input to motor output.

Inhibitory networks can and will dampen certain connections so a slightly larger network can create the same phenomena of a dual set of neurons that stimulate recurrently is large networks without neighboring neurons being activated (see FIG. 7).

Inhibitory networks operate in two modes: 1) in very simple connectomes, inhibition typically will be reserved for motor neuron output, and 2) in larger networks, there is a secondary network of inhibition that will allow dominant neurons to dampen the activity of its neighbors (a winner take all strategy), as well as, a secondary inhibitory network will eventually dampen dominant neurons. In the latter scenario, due to the temporal aspects of neuronal networks, we can excite feed forward neurons for quite some time before the inhibitory neuron begins to stop the Aexcitation.

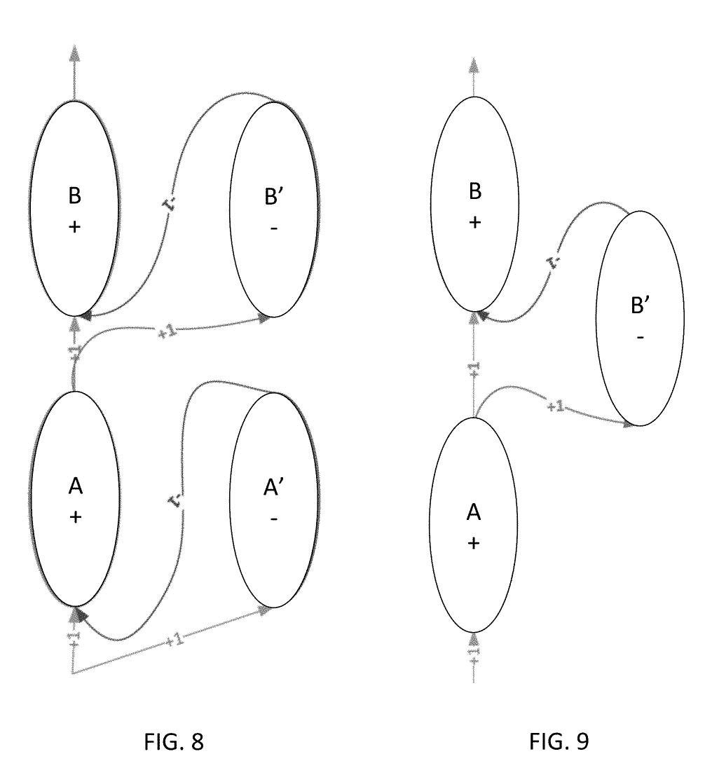

The Inhibitory network is a passive, mirror of the excitatory neurons (see also FIG. 8). Each Inhibitory neuron is stimulated exactly the same as an excitatory neuron, at the same time and the internal temporal algorithm is identical. The only difference is the output of an inhibitory neuron is a negative weighted value.

In addition, inhibitory neurons cannot grow or change their weighted values. In human brains, the inhibitory network is very strong at birth and actually diminishes as we grow into adulthood to create a stable excitatory to inhibitory network that works well in tandem.

The Inhibitory network is delayed by the nature of the spatial-temporal connectivity. In FIG. 9 when Neuron A fires, it stimulates both Neurons B and B′. Neuron B is stimulated immediately and will accumulate weights until a threshold is exceeded and then fire itself. Neuron B′ is also stimulated continuously from Neuron A but it also must accumulate weighted values and exceed a threshold before firing and sending negative weighted values to Neuron B.

Because B and B′ are accumulating simultaneously, all things equal, B will fire before B′ has the chance to negate B. As an example, let's state that the Threshold is 3 (it would be much larger in our “real” connectome model) and A is stimulated constantly.

Connectome Model

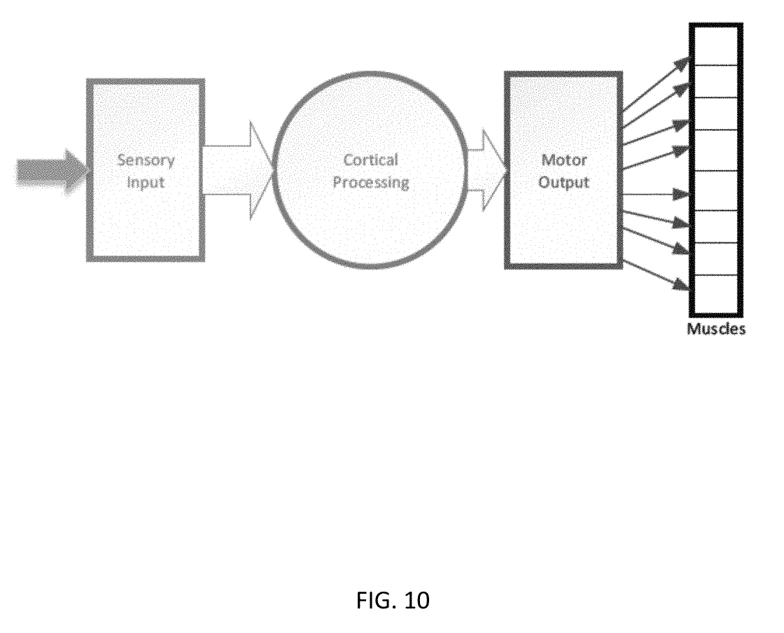

We have seen how Network and Temporal dynamics influence how the connectome is processed. The next step is to view the connectome at a higher functional perspective. As illustrated in FIG. 10, there are three basic components that comprise the connectome model: Sensory Input, Cortical Processing and Motor Output.

Sensory input requires an encoding schema to represent the incoming information. Animal eyes use cones and rods to encode specific light frequencies to varying degrees, ears encode sounds by a fluid that triggers certain hairs connected to neurons within the cochlea, temperature is sensed via different degrees of touch sensors, etc. Likewise, for each type of sensory data we obtain and feed to a PROME cortex, we want to encode the data. Encoding is typically represented in a lexicographical order of some sort due to the nature of how animal nervous systems operate in a semantic methodology.

As an example, if we have a temperature sensor, we may want to sense temperatures from 0 to 90 degrees Fahrenheit where anything below zero and above 90 degrees F. would be detrimental to our robot and would be part of the autonomous nervous system and put a robot into immediate defense mode. What we typically want to look at is changes so we can realize patterns every day for instance where we start out at 60 degrees at 4 am and steadily climb to around 80 and fallback, etc., a daily predictive cycle. If we are starting at 60 degrees and suddenly the temperature starts to climb rapidly (60, 65, 70, 75, 80 . . . ) our system will recognize the rapid change and perform the appropriate actions. Another way to view is if at 12 Noon every day we are usually at 75 degrees give or take a few degrees and now its 10 am and we are at 85, we can detect the change in predictive behavior and assume something is wrong. We can look at this encoding as simply a sequence of numbers 0 to 90 where each digit would represent a stimulation of a specific set of neurons and there would be 91 sensory neurons.

Therefore, we encode using a range and the weighted values of the sensory input determines the strength of the sensory perception. Animal sensory systems are very analog in nature. We might encode a temperature such as 60 degrees as:

And 75 degrees would look like:

This can be represented in the following manner:
SP001072−1→CP00010072
Sensory Neuron SP001072 sends a weight value of one to cortical neuron CP00010072
SP001073−1→CP00010073
Sensory Neuron SP001073 sends a weight value of one to cortical neuron CP00010073
SP001074−2→CP00010074
Sensory Neuron SP001074 sends a weight value of two to cortical neuron CP00010074
SP001075−3→CP00010075
Sensory Neuron SP001075 sends a weight value of three to cortical neuron CP00010075
SP001076−2→CP00010076
Sensory Neuron SP001076 sends a weight value of two to cortical neuron CP00010076
SP001077−1→CP00010077
Sensory Neuron SP001077 sends a weight value of one to cortical neuron CP00010077
SP001078−1→CP00010078
Sensory Neuron SP001078 sends a weight value of one to cortical neuron CP00010078

Note: SP001=sensory organ 001 and CP0001=Cortical area 0001. To explain in analogy, retinal neuron 1 might be connected to visual cortical area level V1 in the human cortex.

Just as in animals, each sensory organ would have a different means to encode its input to specific areas of the PROME cortex but the cortex is agnostic to the sensory data; i.e. cortical structure is the same overall regardless of what sensor data is being received. The only difference in cortical structure is the number of neurons created to handle the sensory encoding.

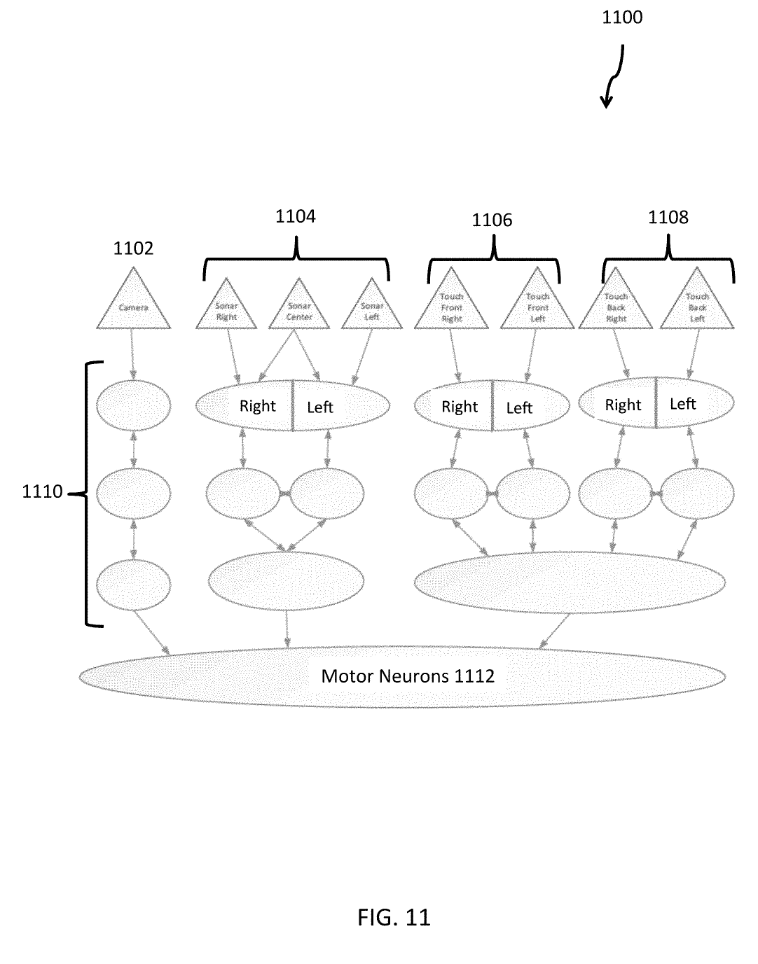

From sensory encoding to the cortex and using the formula given above that for every sensory input, there is 2ⁱ−1 cortical regions, for a robot system of four primary sensory inputs, we would get 2⁴−1=15 cortical regions. Referring to the robot model 1100 represented schematically in FIG. 11, four primary sensory inputs are:
1) Camera 1102
2) Sonar 1104
3) Touch Anterior 1106
4) Touch Posterior 1108

Cortical regions 1110 shown would not only have reciprocal connections between levels of regions as shown but also between levels and different levels of cortical regions. We left them off of the diagram above or it would look more like a bowl of spaghetti than a connectome. Note that each ellipse 1110 that represents a cortical region is comprised of 10s/hundreds/thousands of neurons, excitatory and inhibitory. Each region (ellipse) is a mini connectome in and of itself and the whole is connected in the same small world model with connections. The cortical regions 1110 ultimately connect to the motor neurons 1112.

Considering the four sets of sensory inputs, we have 4!=24 different combinations going into cortical regions. However, we can have stimuli of specific sensory organs that are made up of multiple areas and it is easy to count in the diagram above that we have eight sensory regions due to the sonar is comprised of Right-Center-Left and touch is Right-Left for anterior and posterior. Just like a human has two eyes, we terminate both eyes in one cortical region of our brains. With 8 primary and secondary sensory inputs, we can have 8! or 40,320 combinations of sensory input alone, not counting all the cortical activity. It should be noted here that we restrict sensory input to these combinations alone; i.e. we do not strengthen or weaken sensory pathways. Only cortical pathways display plasticity.

We find in small connectomes that 20% are sensory neurons, 50% are cortical neurons and 30% are motor neurons. We use these ratios to determine the size of an overall connectome in total. Each connectome is streamlined to the type of organism it represents. Using the connectome above with four primary sensory inputs, we can break down the sensory neurons needed as:

Camera: Even though we may use a 5 MP camera, animal eyes only sense a small area (see comparisons below). Let's consider 5% of the total image that we would consider as important. 5% of 4,915,200 pixels=245,760×3 for primary colors (red, green, blue)=737,280 sensory neurons.

Sonars: We might say we don't care about distances over 150 cm and we have a left and right so we might say we have 300 sensory neurons for sonars.

Touch Anterior and Touch Posterior: These sensors are on and off switches so we have 4 switches or 4 neurons. 737,280+300+4=737,584 total sensory neurons. If this represents 20% of the total neurons, we can have 1,843,960 cortical neurons total (50%) and 1,106,376 motor neurons (30%). Total “brain” or connectome would be comprised of 4,425,504 neurons or nodes.

The human eyes have approximately a total of 252,000,000 neurons (rod and cones) so using just 737,584 may seem like a large number but in comparison it is small. Furthermore if all we need to do is see like a dog (no color), we can reduce the total neurons down to 1,230,320; color adds a significant increase.

If we take just the sonar sensor cortical regions, we see a right/left division which may be comprised of 300 sensory neurons total, 150 on the left and 150 on the right. For left and right sonar sensory input, this is simple. A sonar reading of 140 cm on the Left sonar would look like:

On the Right sonar:

On the Center sonar:

Note both left and right sides are stimulated for center readings.

Using the “Building Artificial Connectome” principles above, each cortical region would be created using these rules. Like cortical regions would be tied together in a similar fashion and the entire cortex would be applied using the same rules. This is fractal in nature as we express a connectome at its smallest entity and as we add more subcortical regions, we apply these same rules. What we end up with is the same as in nature where each small cortical region is highly recurrent and as we move outward to combining subcortical regions, we find recurrent connections but not as dense as within a subcortical region.

As an example, in the above layout, we have 15 cortical regions. We can view these regions as 15 nodes. Then we can apply the Watts-Strogatz formula and connect these 15 regions to one another. Some have looked at this as a hierarchical pattern but it is not. It is A complex network where all regions are equal so no hierarchy truly exists.

As with animals, all our actions result in motor output, real or virtual. Real motor output is when we make a physical change in our environment whether that is speaking and creating a ripple across the air in the form of sound waves or moving an arm to make a gesture or move an object. Virtual motor output is when we imagine an action and do not change the physical space around us but we play that change in our minds. What's important is everything we process in our cortex is a movement. Everything!

In fact it should be noted that all sensory input is based on movement, real or virtual. If a marble is placed between your fingers and you could not see it, the only way you could tell what it was is to move the marble between your fingers and/or see it with your eyes (note your eyes are constantly moving as saccades).

As an example of real time processing, the following is a capture of connectomic activity after the 45 sensors were processed over 30,000 times:

| | |
|---|---|
| Excitatory Stimulation | 2,936,644 |
| Inhibitory Stimulation | 1,044,147 |
| Synaptic Strengthening | 10,222 |
| Synaptic Weakening | 7,064 |
| Synaptic Growth | 10,204 |
| Synaptic Pruning | 2,705 |
| Muscle Stimulation | 811,493 |

The above Table demonstrates the following:
2,936,644 excitatory neuron stimulations, or neuron stimulations of a positive weighted value.
1,044,147 inhibitory neuron stimulations, or neuron stimulations of a negative weighted value.
10,222 incidences of synaptic strengthening where values were added to already existing synaptic weights.
7,064 incidences of synaptic weakening where values were decremented from already existing synaptic weights.
10,204 times that new connections between neurons were formed.
2,705 times when existing connections between neurons were removed.

Excitatory and Inhibitory stimulation regulates the flow dynamics of the connectome. Synaptic strengthening and weakening alter and shape the flow dynamics. Synaptic growth and pruning is the plasticity on the connectome that alters the structure of the connectome and shapes learning of the various input stimuli.

### IV. Muscles/Motor Output

Motor output is a paradigm in and of itself. It has no direct relation to sensory input. A real difference between mathematical models like Deep Learning and Biologic Intelligence, is that mathematical models have a direct correlation to input. Without input, a Deep Learning system does not function. Humans are not tied to sensory input to create movement or output. When a person wakes in the morning, the mind tells him/her to move out of bed. He/she does not need an external sensory input to make that happen. However, it is obvious that the sound of an alarm or sunlight can create sensory input to make the person wake but only cortical processing will make him/her move out of bed. So this is not to say that sensory input won't trigger thoughts to cause motor output. What Biologic Intelligence purports is that there is no direct correlation; i.e. every time the person sees sunlight and is laying in a bed, that input doesn't make him/her move out of the bed. If he/she wants to take an afternoon nap, sunlight plays no part of whether he/she is in a bed or not. A Deep Learning system would have a very difficult time being trained by this factor unless sunlight was never part of the training set. With Biologic Intelligence, sensory input and motor output are two distinct and different systems, working completely independently, tied together through a cortical model.

Motor output is determined by the type of output we desire. Sounds very simple and to some degree it is. If we have motors controlling the wheels of a robot then we need enough motor neurons to muscles to make that control smooth and feasible. If we have speech, then we need enough motor neurons to enable the words we want our system to speak; e.g. if our system is to give a speech about the thermodynamics, we obviously would need more motor neurons involved than if all our system needs to do is say Yes or No. Likewise, do we just have a right and left wheel motor for movement or do we also have an articulated arm. Each case and example demands different numbers of nodes. There is no rule of thumb to the number of muscles. Humans have just over 600 muscles, a cat has over 300 and a centipede has 4000. What does matter is that we need at least 60% more cortical neurons that we have motor neurons. This is natures design. How the motor neurons terminate to a muscle is determined by the functional aspects of what we want to move.

All animal output is muscle movement, virtual or physical. Everything we do, think or act upon in some way is associated to a muscle movement. Even qualia like “love” is always expressed in an action. So just the same as input always must involve movement to identify an object or sensation, output always is derived by muscle output. Virtual output is just the output that is expressed in our minds but not resulting in an actual physical action. What has been discovered is when we conclude anything, our motor cortex is lit up just the same as if we were doing some physical action with our muscles. One of the main differences between higher and lower animals is that higher animals can internalize and disconnect muscle activity from the physical world. Lower animals cannot do this disconnect and thus all thoughts are a physical movement.

Interpretation of Motor Output

Interpretation of motor output can be defined as the results of what the system has learned. There are several methods of motor output interpretation. The easiest interpretation is physical output. If we have motors attached to a robot that Biologic Intelligence is driving, then either the system is moving such that it achieves a goal or its movements are misdirected (e.g. crashes). We can usually visually decide whether a physical movement is interpreted as successful or as a failure. Feedback to the cortex can be instituted by reward or punishment (see below).

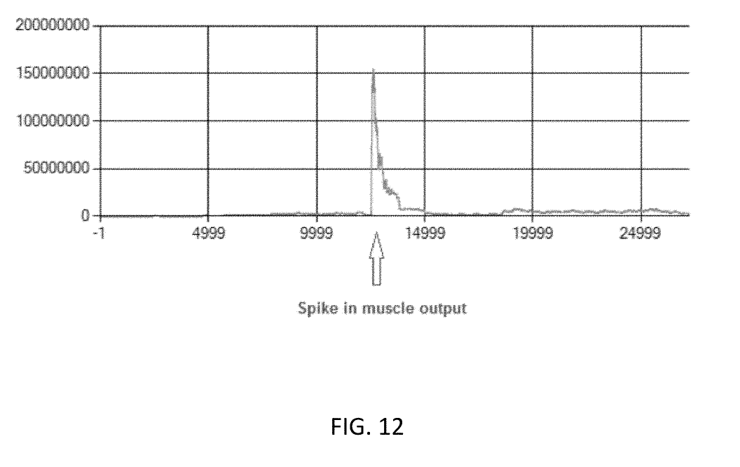

The second order of motor output is just the accumulation of muscle activity. This is simply taking the summation of all muscle derived weighted values each time a single muscle is activated and then plotting the summation so that when an unusual amount of activity is given, we know a change in the system has occurred. Using real values from a sensor company, the graph in FIG. 12 that was plotted as the sensor data was processed through the connectome shows an obvious spike in muscle output. This spike is the reaction to unusual sensor activity much like an animal might be agitated in an uncomfortable environment.

| | |
|---|---|
| Runtime | 2,255 |
| Excitatory Stimulation | 2,936,644 |
| Inhibitory Stimulation | 1,044,147 |
| Synaptic Strengthening | 10,222 |
| Synaptic Weakening | 7,064 |
| Synaptic Growth | 10,204 |
| Synaptic Pruning | 2,705 |
| Muscle Stimulation | 811,493 |

The graph shows the results after processing 45 sensors, 30,000 times. The Table shows the results of the cortical processing and the graph to the immediate right is the accumulation of motor activity.

The third order of motor output is what Numenta calls a “classifier.” This is an application that connects the sensory input to the output and is very useful with anomaly detection and predictive analysis. In Biologic Intelligence terms, we capture a muscle signature and identify that signature to a specific sensory paradigm. As an example, we may be processing a set of images as sensory input. Each image will derive a muscle output that is directly correlated to a given image. If we want to identify like images, we can review the set of muscle signatures and see which signatures are alike.

A muscle signature is what muscles were activated and at what intensity for a given input. If we have as an example five muscles and if image A creates a signature of muscle to intensity as: Muscle 1:200 or Muscle 1 has been activated by motor neurons 200 times for a given time, Muscle 2:0, Muscle 3:0, Muscle 4:300 and Muscle 5:250, then image B is 1:50, 2:0, 3:300, 4:195, 5:0, image C is 1:190, 2:10, 3:0, 4:305, and 5:244. We can correlate that image A and image C are closely related.

The rules are values must not be zero and within 20% of each other.

| Image | Muscle | # of activations | Correlation | Score |
|---|---|---|---|---|
| A | 1 | 200 | C | B: 0 |
| | 2 | 0 | | C: 3 |
| | 3 | 0 | | |
| | 4 | 300 | C | |
| | 5 | 250 | C | |
| B | 1 | 155 | C | A: 0 |
| | 2 | 0 | | C: 1 |
| | 3 | 300 | | |
| | 4 | 195 | | |
| | 5 | 0 | | |
| C | 1 | 190 | A | A: 3 |
| | 2 | 0 | | B: 1 |
| | 3 | 0 | | |
| | 4 | 305 | A | |
| | 5 | 244 | A | |

Therefore, the score between A and C=3=match, indicating a like image.

When we record signatures over time intervals, we can create a pattern for each interval by the timestamp. So looking at the table above, if we were to change the Image column to a timestamp, and record muscle output at a specific time each time interval (e.g. every 5 minutes, each hour, each day, each week, etc.) we can create a pattern of time specific correlations. Over a broad range of repeatable time, we can create a match sequence and thus predict at a specific interval what the pattern would be. If a pattern does not match a specific sequence at a specific interval, then we know there is an anomaly detected. Therefore, knowing at time T1 the muscle output is always 1:0, 2:200, 3:100, 4:50 and 5:0, if we see at time T1 1:500, 2:0, 3:0, 4:22, 5:200 then we know there is something different. Furthermore, by recording the sensory input at each interval as well as the output, we can match anomalies to other time intervals to see if there are any matches for possible reasons why the anomaly exists.

In this scenario, we can predict a specific input at a specific time, anomalies when they occur and possibly reasons why an anomaly is present. These types of correlations can be useful to everything from factory automation to business continuity to Internet of Things (IoT) performance.

The real power of Biologic Intelligence comes in the form of learning to predict an outcome that has not been given or foreseen in the past. The network dynamics of connectomics gives us this capability as animals. The problem with the second order of muscle output is that it doesn't require muscle output per se. What we are really doing is take a snapshot of the cortex and neuron activity at specific time intervals. This is the fallacy of systems like Numenta is they only consider cortical processing and stop there. They typically use a mathematical approach to derive a value to determine output.

### V. Contrasting Biologic Intelligence to Other AI Paradigms

We are often asked about benchmarks and specifically, the classic benchmarks used to compare versions of other AI paradigms. Let me talk about two AI paradigms that are well known and why it is difficult or not fruitful to compare their benchmarks against Biologic Intelligence. To state it another way, Biologic Intelligence is like animal or human intelligence so it is in a class by itself at this time. This section is not trying to define which paradigm is better at a specific task but only serves to explain why certain benchmarks are not the same across paradigms and in fact, most benchmarks are designed specifically for a particular paradigm.

Deep Learning

We often hear about ImageNet as a benchmark and certainly one of the premier benchmarks for Deep Learning systems. Deep Learning and specifically Convolutional Neural Networks (also known as Covnets or CNNs) take an image (picture) and break it into small subpictures. A 32×32 pixel image might be broken into 4×4 subpictures and these subpictures are manipulated and fed into a series of artificial neural networks, at each level given a value and passed along until there is a final evaluation or value assigned to the image as a whole. By breaking down the image, small and specific features can be derived and formulated. This is why when we run other “like” images we get false readings.

Likewise Biologic Intelligence does not have the capability to break down an image like Deep Learning because Biologic Intelligence is more cortical in nature than sensory. We know for instance that our eyes do not work like the neocortex of our brains; i.e. the neural structure and dynamics are completely different.

Animal vision systems do a saccade across an image and pick up a few points to process and can identify images very well in doing so. A 32×32 image has an obvious 1,024 pixels total. CNNs must process all 1,024 pixels at some level even if a good number of these pixels are discarded due to a lack of features or small values after being evaluated. The human eye would do a saccade over the image and focus on just a few points. Even if a human looked at 30 points on an image, this would be considerably less than what a Deep Learning system would need to do in order to make a determination.

Saccades and how animal vision works is much different than how Deep Learning works. Saccades and the after cortical processing is dependent on detail of an image as in light and dark features as well as angles within the image and how long a person stares at the image.

Furthermore, the ImageNet data is broken into high level classifications so you can have tens or hundreds of pictures under a single category such as a few hundred pictures of cats which are classified as a cat and not any more. This allows a Deep Learning system to discriminate features within an image whereas if an image has a cat in it but has many more items also contained in the image, by breaking an image into components, a Deep Learning system can find the feature set that equates to a specific value and declare that picture contains a cat as well as define where in that picture the cat exists based on that value.

Feeding an entire image, pixel by pixel, into a Biologic Intelligence system makes absolutely no sense. If one is made to look at an image pixel by pixel, how well would one be able to discriminate what the image was or what was contained in the image? For a Biologic Intelligence system to properly work, we must use saccades like an animal and quickly scan for specific features and through the angles and placements of those features, Biologic Intelligence can derive what an image is. If ImageNet had images just of a cat and no other items in the image, and specific labels such as cat, the type of cat and all the attributes of each cat in an image, Biologic Intelligence would be well suited to benchmark against ImageNet. Since Biologic Intelligence does not reduce an image to a value through a series of functions, it does not have the ability to discriminate images made up of a multitude of items to a single category. In other words, if an image contained a cat, a ball, flowers and a dish, Biologic Intelligence must be given focus on each of the items and told what each item is to understand what a cat is. If a child is shown several pictures that had a multitude of items, items that the child never had seen before or knew any of the items in the images, as well as, a cat was in each image and just told the child cat without pointing to the specific item in the image that was a cat, the child would be very confused as to what a cat was. Until we are given specific images of an object and told what that object is, and then given images that contain many other items, and specific objects are pointed out and defined, can we begin to discriminate and understand future images. However, only with a few examples, we learn that discrimination for a lifetime.

Feeding hundreds of images that contains cats to a Biologic Intelligent system which just the label “cat”, a Biological Intelligence system might start to learn what a cat “might” be but just giving a few examples of images of just a cat and no other clutter would guarantee the discrimination we desire.

However, given a picture that contains a cat, ball, dish and flower and having given examples of each by themselves, when a Biologic Intelligence system viewed the image and asked what it was, One would expect an answer of “cat, ball, dish and flower”, not just “cat”.

Therefore, ImageNet is not designed for Biologic Intelligence and it is a fallacy to ask for a benchmark comparison.

Hierarchical Temporal Memory (HTM)

Biologic Intelligence is sometimes compared to Hierarchical Temporal Memory (HTM) by Numenta. HTM is stated as similar in nature to how the human brain processes information in the cortex and more specifically, in how information is processed in cortical columns. This is not true for the most part but that is a separate discussion.

Numenta created the Numenta Anomaly Benchmark (NAB) that has had little success outside of Numenta as a benchmark and mainly, like ImageNet, was designed specifically for the HTM paradigm. Anomaly detection is the means to discover patterns over time and when something or someone deviates from that temporal pattern, the system alerts to that deviation.

Numenta's HTM architecture is well suited for this type of discovery because HTM is very much like the old analog memory systems. HTM also uses a neural network evaluation function as output from the HTM system to create a value that can be used to discriminate results from inputs. By recording these output values over time, a pattern is captured and created and deviations from that pattern can be quickly recognized.

A main difference from HTM and Biologic Intelligence is that HTM stops functioning at the cortical level where Biologic Intelligence is a complete end to end system (sensory input to motor output). For Biologic Intelligence to compete with HTM and benchmark using NAB, we would have to redesign the Biologic Intelligence system to only process to the cortical level and then capture the results from that level to some function for evaluation over time.

Therefore, Biologic Intelligence would serve no benefit to use the NAB benchmark as a comparison of capabilities since Biologic Intelligence would have to be redesigned to use the benchmark and the redesign would have to be very similar to HTM in nature.

In general, the common thread with benchmarks is that they are designed for a specific paradigm as a means to contrast and improve that paradigm. Benchmarks can seldom, if ever, be used to contrast the differences between paradigms that are unalike. Biologic Intelligence is not like Deep Learning or HTM so for anyone to use a specific benchmark as means to prove or disprove the viability of any of these two different paradigms, is a misnomer, will not contrast and will not be useful in providing valid results. AI paradigms come in many different flavors and like most disciplines, have completely different architectures to support the types of things they are trying to accomplish. Benchmarks are always tied to a specific architecture. We can't say a downhill skier is a better athlete than a 100 m butterfly swimmer and we would not attempt to use a benchmark designed for one to prove the viability of the other.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method to emulate a biological neuron, comprising:
a) connecting the emulated neuron to at least one other neuron;
b) receiving weighted values from the at least one other connected neuron;
c) accumulating the weighted values;
d) determining if the neuron has been inactive (not fired) for a predetermined time and, if so, resetting all accumulated values to zero and returning to step b);
e) if the neuron has not been inactive for the predetermined time, determining if a predetermined accumulation threshold has been reached and, if not, returning to step b);
f) if the predetermined accumulation threshold has not been reached, triggering the neuron to fire and sending positive weight accumulations to the at least one other connected neuron;
g) accumulating a Learning value;
h) determining if a predetermined Learning threshold has been reached and, if not, returning to step b);
i) if the predetermined Learning threshold has been reached, incrementing a post-synaptic Growth value and resetting the Learning value to zero;
j) determining if a predetermined Growth threshold has been reached and, if not, returning to step b);
k) if the Growth threshold has been reached, adding a post-synaptic weight to simulate synaptic Growth, resetting the Growth value to zero, and returning to step b); and
i) simultaneously with steps b)-k), accumulating and processing parallel inhibitory values.
